(19) United States
(12) Patent Application Publication
(10) Pub. No.: US 2026/0357543 A1
(43) Pub. Date: Nov. 12, 2026

(54) ABNORMALITY DIAGNOSIS SYSTEM AND ABNORMALITY DIAGNOSIS METHOD

(71) Applicant: KAWASAKI JUKOGYO KABUSHIKI KAISHA, Kobe-shi, Hyogo (JP)

(72) Inventors: Kazuya NAGAMUNE, Kobe-shi (JP); Yousuke KATAOKA, Kobe-shi (JP)

(73) Assignee: KAWASAKI JUKOGYO KABUSHIKI KAISHA, Kobe-shi, Hyogo (JP)

(21) Appl. No.: 19/127,250

(22) PCT Filed: Dec. 11, 2023
(86) PCT No.: PCT/JP2023/044212

§ 371 Date: May 5, 2025

(30) Foreign Application Priority Data
Mar. 30, 2023 (JP) 2023-054909

(51) Int. Cl. E02F 9/26; E02F 3/32; E02F 9/02; E02F 9/12; E02F 9/22; F04B 51/00; F15B 19/00

(52) U.S. Cl. CPC E02F 9/267; E02F 9/226; E02F 9/2296; F04B 51/00; F15B 19/00; E02F 3/32; E02F 9/02; E02F 9/123; E02F 9/2203; E02F 9/2285; E02F 9/2292

(57) ABSTRACT

An abnormality diagnosis system according to one embodiment is a system for diagnosing an abnormality in a hydraulic pump of a variable displacement type, the hydraulic pump being installed on a construction machine, the abnormality diagnosis system including: a pressure meter that detects a suction pressure, a delivery pressure, or a drain pressure of the hydraulic pump; and control circuitry. The control circuitry determines whether or not there is an abnormality in the hydraulic pump based on the pressure detected by the pressure meter in a state where the construction machine is operated under predetermined diagnostic conditions. The predetermined diagnostic conditions are a rotation speed and a load of the hydraulic pump being kept constant and a displacement of the hydraulic pump being kept to a predetermined value greater than a minimum value.

### TECHNICAL FIELD

The present disclosure relates to an abnormality diagnosis system for, and an abnormality diagnosis method of, diagnosing an abnormality in a hydraulic pump installed on a construction machine.

### BACKGROUND ART

Construction machines such as a hydraulic excavator include hydraulic equipment installed thereon, such as a hydraulic pump and a hydraulic actuator. The hydraulic pump is, in general, a variable displacement pump.

For example, Patent Literature 1 discloses an abnormality detector to detect the delivery pressure of a hydraulic pump that is an axial piston pump and to detect an abnormality in the hydraulic pump based on the detected delivery pressure.

### CITATION LIST

### Patent Literature

PTL 1: Japanese Laid-Open Patent Application Publication No. 2013-170509

### SUMMARY OF INVENTION

### Technical Problem

Incidentally, in order to determine, with high precision, whether or not there is an abnormality in a hydraulic pump based on a pressure related to the hydraulic pump, such as a delivery pressure, it is important under what conditions the pressure is to be detected. However, Patent Literature 1 gives no description in this regard.

In view of the above, an object of the present disclosure is to provide an abnormality diagnosis system and an abnormality diagnosis method that make it possible to determine, with high precision, whether or not there is an abnormality in a hydraulic pump.

### Solution to Problem

One aspect of the present disclosure provides an abnormality diagnosis system for diagnosing an abnormality in a hydraulic pump of a variable displacement type, the hydraulic pump being installed on a construction machine, the abnormality diagnosis system including: a pressure meter that detects a suction pressure, a delivery pressure, or a drain pressure of the hydraulic pump; and control circuitry that determines whether or not there is an abnormality in the hydraulic pump based on the pressure detected by the pressure meter in a state where the construction machine is operated under predetermined diagnostic conditions. The predetermined diagnostic conditions are a rotation speed and a load of the hydraulic pump being kept constant and a displacement of the hydraulic pump being kept to a predetermined value greater than a minimum value.

Another aspect of the present disclosure provides an abnormality diagnosis method of diagnosing an abnormality in a hydraulic pump of a variable displacement type, the hydraulic pump being installed on a construction machine, the abnormality diagnosis method including, in a state where the construction machine is operated under predetermined diagnostic conditions, detecting a suction pressure, a delivery pressure, or a drain pressure of the hydraulic pump and determining whether or not there is an abnormality in the hydraulic pump based on the detected pressure. The predetermined diagnostic conditions are a rotation speed and a load of the hydraulic pump being kept constant and a displacement of the hydraulic pump being kept to a predetermined value greater than a minimum value.

### Advantageous Effects of Invention

The present disclosure provides an abnormality diagnosis system and an abnormality diagnosis method that make it possible to determine, with high precision, whether or not there is an abnormality in a hydraulic pump.

### BRIEF DESCRIPTION OF DRAWINGS

FIG. 1 shows a schematic configuration of an abnormality diagnosis system according to one embodiment and that of a hydraulic system including hydraulic pumps.

FIG. 2 shows a state where a left crawler of a hydraulic excavator is lifted in the air.

### DESCRIPTION OF EMBODIMENTS

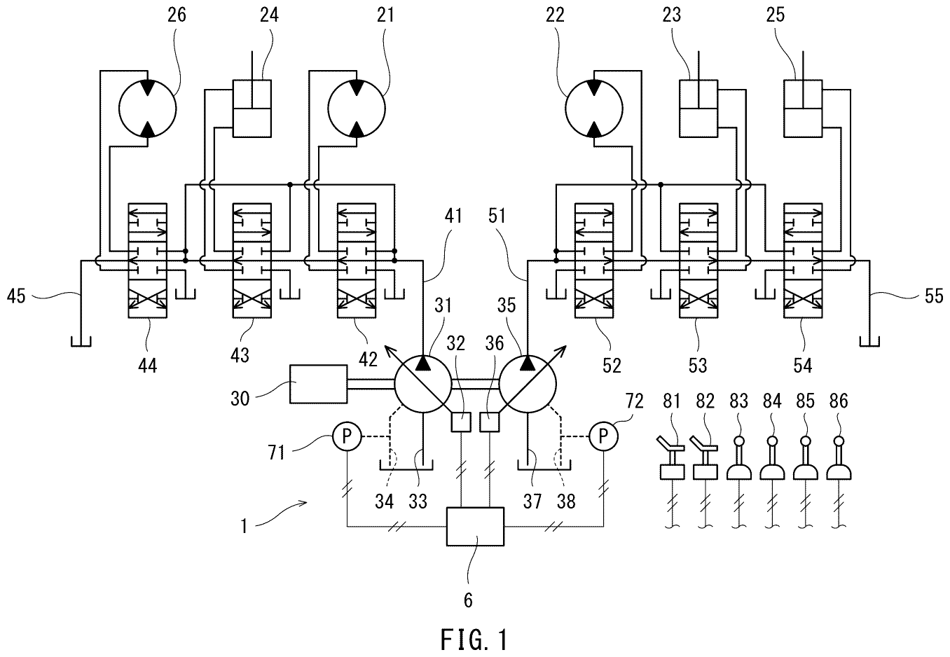

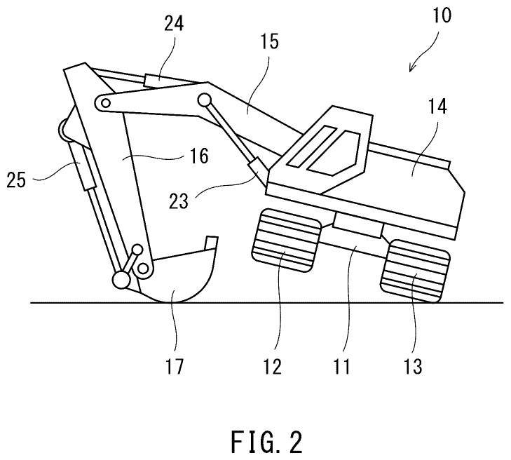

FIG. 1 shows a hydraulic system including at least one hydraulic pump and an abnormality diagnosis system 1 according to one embodiment for diagnosing an abnormality in the hydraulic pump. FIG. 2 shows a hydraulic excavator 10, on which the hydraulic system is installed. The abnormality diagnosis system 1 is applicable also to a hydraulic pump installed on a construction machine that is not the hydraulic excavator 10 but is, for example, a wheel loader.

As shown in FIG. 2, the hydraulic excavator 10 includes a traveling structure 11 and a slewing structure 14 slewably supported by the traveling structure 11. The traveling structure 11 includes a left crawler 12 and a right crawler 13 as a pair of crawlers. The hydraulic excavator 10 further includes: a boom 15, which is luffed relative to the slewing structure 14; an arm 16 swingably coupled to the distal end of the boom 15; and a bucket 17 swingably coupled to the distal end of the arm 16.

As shown in FIG. 1, the hydraulic system includes a left travel motor 21, a right travel motor 22, a boom cylinder 23, an arm cylinder 24, a bucket cylinder 25, and a slewing motor 26 as hydraulic actuators. The left travel motor 21 and the right travel motor 22 drive the left crawler 12 and the right crawler 13, respectively, and the boom cylinder 23 luffs the boom 15. The arm cylinder 24 and the bucket cylinder 25 swing the arm 16 and the bucket 17, respectively, and the slewing motor 26 slews the slewing structure 14.

In the present embodiment, the hydraulic system includes two hydraulic pumps, i.e., a first hydraulic pump 31 and a second hydraulic pump 35. The first hydraulic pump 31 supplies hydraulic oil to the left travel motor 21, the arm cylinder 24, and the slewing motor 26, whereas the second hydraulic pump 35 supplies the hydraulic oil to the right travel motor 22, the boom cylinder 23, and the bucket cylinder 25. Alternatively, the number of hydraulic pumps installed on the hydraulic excavator 10 may be one, or three or more.

To be more specific, the first hydraulic pump 31 is connected to a tank by a suction line 33, and connected to a left travel control valve 42, an arm control valve 43, and a slewing control valve 44 by a supply line 41. The left travel control valve 42 is connected to the left travel motor 21 by a pair of supply/discharge lines. The arm control valve 43 is connected to the arm cylinder 24 by a pair of supply/discharge lines. The slewing control valve 44 is connected to the slewing motor 26 by a pair of supply/discharge lines.

The left travel control valve 42 changes the rotation direction and the rotation speed of the left travel motor 21 in accordance with the operating direction and the operating amount of a below-described left travel operator 81. The arm control valve 43 changes the moving direction and moving speed of the arm cylinder 24 in accordance with the operating direction and the operating amount of a below-described arm operator 84. The slewing control valve 44 changes the rotation direction and the rotation speed of the slewing motor 26 in accordance with the operating direction and the operating amount of a below-described slewing operator 86.

In the present embodiment, a center bypass line 45 is branched off from the supply line 41, and the center bypass line 45 extends to the tank by passing through the left travel control valve 42, the arm control valve 43, and the slewing control valve 44.

Alternatively, instead of the center bypass line 45, an unloading line on which an unloading valve is located and that connects between the supply line 41 and the tank may be adopted.

Similarly, the second hydraulic pump 35 is connected to the tank by a suction line 37, and connected to a right travel control valve 52, a boom control valve 53, and a bucket control valve 54 by a supply line 51. The right travel control valve 52 is connected to the right travel motor 22 by a pair of supply/discharge lines. The boom control valve 53 is connected to the boom cylinder 23 by a pair of supply/discharge lines. The bucket control valve 54 is connected to the bucket cylinder 25 by a pair of supply/discharge lines.

The right travel control valve 52 changes the rotation direction and the rotation speed of the right travel motor 22 in accordance with the operating direction and the operating amount of a below-described right travel operator 82. The boom control valve 53 changes the moving direction and the moving speed of the boom cylinder 23 in accordance with the operating direction and the operating amount of a below-described boom operator 83. The bucket control valve 54 changes the moving direction and the moving speed of the bucket cylinder 25 in accordance with the operating direction and the operating amount of a below-described bucket operator 85.

In the present embodiment, a center bypass line 55 is branched off from the supply line 51, and the center bypass line 55 extends to the tank by passing through the right travel control valve 52, the boom control valve 53, and the bucket control valve 54. Alternatively, instead of the center bypass line 55, an unloading line on which an unloading valve is located and that connects between the supply line 51 and the tank may be adopted.

In the present embodiment, the first hydraulic pump 31 and the second hydraulic pump 35 are driven by an engine 30. The engine 30 drives each of the first hydraulic pump 31 and the second hydraulic pump 35 at a constant rotation speed. Alternatively, the first hydraulic pump 31 and the second hydraulic pump 35 may be driven by an electric motor.

Each of the first hydraulic pump 31 and the second hydraulic pump 35 is a variable displacement pump. In the present embodiment, each of the first hydraulic pump 31 and the second hydraulic pump 35 is an axial piston pump whose tilting angle is changeable, such as a swash plate pump or a bent axis pump. Alternatively, each of the first hydraulic pump 31 and the second hydraulic pump 35 may be a different type of pump, such as a vane pump.

The displacement of the first hydraulic pump 31 is changed by a regulator 32, and the displacement of the second hydraulic pump 35 is changed by a regulator 36. In the present embodiment, the regulators 32 and 36 are controlled by control circuitry 6. For example, in a case where the first hydraulic pump 31 is a swash plate pump, the regulator 32 may electrically change a hydraulic pressure applied to a servo piston coupled to the swash plate of the first hydraulic pump 31, or may be an electric actuator coupled to the swash plate of the first hydraulic pump 31. Similarly, in a case where the second hydraulic pump 35 is a swash plate pump, the regulator 36 may electrically change a hydraulic pressure applied to a servo piston coupled to the swash plate of the second hydraulic pump 35, or may be an electric actuator coupled to the swash plate of the second hydraulic pump 35.

However, each of the regulators 32 and 36 need not be controlled by the control circuitry 6, but may be moved by the pressure of the hydraulic oil. For example, each of the regulators 32 and 36 may be controlled by negative control, or may be controlled by load-sensing control.

Regarding the control circuitry 6, the functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The slewing structure 14 of the hydraulic excavator 10 includes a driver's cab. The inside of the driver's cab is equipped with the left travel operator 81, the right travel operator 82, the boom operator 83, the arm operator 84, the bucket operator 85, and the slewing operator 86.

Each of the left travel operator 81 and the right travel operator 82 includes a pedal, and outputs an operation signal corresponding to the operating amount of the pedal. Each of the boom operator 83, the arm operator 84, the bucket operator 85, and the slewing operator 86 includes a lever, and outputs an operation signal corresponding to the operating amount of the lever. The boom operator 83 and the bucket operator 85 may be integrated together, and may share the same lever. The arm operator 84 and the slewing operator 86 may be integrated together, and may share the same lever.

In the present embodiment, each of the left travel operator 81, the right travel operator 82, the boom operator 83, the arm operator 84, the bucket operator 85, and the slewing operator 86 outputs an electrical signal as an operation signal, and the outputted operation signal is inputted to the control circuitry 6. Alternatively, each of the left travel operator 81, the right travel operator 82, the boom operator 83, the arm operator 84, the bucket operator 85, and the slewing operator 86 may output a pilot pressure to the corresponding control valve as an operation signal. In this case, the pilot pressure outputted to the control valve is detected by a pressure meter, and inputted to the control circuitry 6.

When none of the left travel operator 81, the right travel operator 82, the boom operator 83, the arm operator 84, the bucket operator 85, or the slewing operator 86 is operated, the control circuitry 6 controls the regulators 32 and 36 such that the displacement of each of the first hydraulic pump 31 and the second hydraulic pump 35 is the minimum value. In the present embodiment, the minimum value of the displacement of each of the first hydraulic pump 31 and the second hydraulic pump 35 is 0%, and the maximum value thereof is 100%. When the displacement of each of the first hydraulic pump 31 and the second hydraulic pump 35 is 0%, the delivery flow rate of each of the first hydraulic pump 31 and the second hydraulic pump 35 is greater than zero.

On the other hand, when any one of the left travel operator 81, the arm operator 84, or the slewing operator 86 is operated, in accordance with an increase in the operating amount of the operator, the control circuitry 6 increases the displacement of the first hydraulic pump 31. Further, when any one of the right travel operator 82, the boom operator 83, or the bucket operator 85 is operated, in accordance with an increase in the operating amount of the operator, the control circuitry 6 increases the displacement of the second hydraulic pump 35.

A pressure related to the first hydraulic pump 31 is detected by a pressure meter 71, and inputted to the control circuitry 6. Similarly, a pressure related to the second hydraulic pump 35 is detected by a pressure meter 72, and inputted to the control circuitry 6.

In the present embodiment, the pressure meter 71 is located on a drain line 34 of the first hydraulic pump 31, and detects the drain pressure of the first hydraulic pump 31, whereas the pressure meter 72 is located on a drain line 38 of the second hydraulic pump 35, and detects the drain pressure of the second hydraulic pump 35. The pressure meter 71 may be mounted to the casing of the first hydraulic pump 31, or may be mounted to a drain pipe that connects between the first hydraulic pump 31 and the tank. Similarly, the pressure meter 72 may be mounted to the casing of the second hydraulic pump 35, or may be mounted to a drain pipe that connects between the second hydraulic pump 35 and the tank.

Alternatively, the pressure meter 71 may be located on the suction line 33 and detect the suction pressure of the first hydraulic pump 31, or may be located on the supply line 41 and detect the delivery pressure of the first hydraulic pump 31. Similarly, the pressure meter 72 may be located on the suction line 37 and detect the suction pressure of the second hydraulic pump 35, or may be located on the supply line 51 and detect the delivery pressure of the second hydraulic pump 35.

The drain pressure of the first hydraulic pump 31 is detected by the pressure meter 71 in a state where the hydraulic excavator 10 is operated under predetermined diagnostic conditions related to the first hydraulic pump 31. The predetermined diagnostic conditions related to the first hydraulic pump 31 are the rotation speed and the load of the first hydraulic pump 31 being kept constant and the displacement of the first hydraulic pump 31 being kept to a predetermined value a greater than the minimum value. In the present embodiment, the predetermined value a is 50% or greater and 100% or less. Alternatively, the predetermined value a may be 70% or greater and 100% or less.

In the present embodiment, the state where the hydraulic excavator 10 is operated under the predetermined diagnostic conditions related to the first hydraulic pump 31 is, as shown in FIG. 2, a state where the left crawler 12 of the hydraulic excavator 10 is lifted and driven in the air. Specifically, the driver slews the slewing structure 14 to the left relative to the traveling structure 11, and in this state, pushes the bucket 17 to the ground. At the time, the direction in which the pedal of the left travel operator 81 is stepped on may be either the forward travel direction or the backward travel direction. Also, the amount by which the pedal is stepped on may be the maximum amount, or may be a constant amount less than the maximum amount.

In this state where the left crawler 12 is driven in the air, the drain pressure of the first hydraulic pump 31 is detected by the pressure meter 71. The control circuitry 6 determines whether or not there is an abnormality in the first hydraulic pump 31 based on the detected drain pressure. For example, the control circuitry 6 may determine whether or not there is an abnormality in the first hydraulic pump 31 by comparing the waveform of the detected drain pressure with a normal waveform, or may determine whether or not there is an abnormality in the first hydraulic pump 31 by comparing the detected drain pressure at a specific timing with a threshold. Alternatively, the control circuitry 6 may determine whether or not there is an abnormality in the first hydraulic pump 31 by performing frequency analysis on the detected drain pressure.

Desirably, the control circuitry 6 determines whether or not there is an abnormality in the first hydraulic pump 31 after confirming that the delivery pressure of the first hydraulic pump 31 is kept to a predetermined value B. For example, the predetermined value β is 1 MPa or greater and 20 MPa or less. Alternatively, the predetermined value may be 1 MPa or greater and 10 MPa or less.

The drain pressure of the second hydraulic pump 35 is detected by the pressure meter 72 in a state where the hydraulic excavator 10 is operated under predetermined diagnostic conditions related to the second hydraulic pump 35. The predetermined diagnostic conditions related to the second hydraulic pump 35 are the rotation speed and the load of the second hydraulic pump 35 being kept constant and the displacement of the second hydraulic pump 35 being kept to a predetermined value y greater than the minimum value. In the present embodiment, the predetermined value y is 50% or greater and 100% or less. Alternatively, the predetermined value y may be 70% or greater and 100% or less.

In the present embodiment, the state where the hydraulic excavator 10 is operated in a manner to satisfy the predetermined diagnostic conditions related to the second hydraulic pump 35 is, conversely to FIG. 2, a state where the right crawler 13 of the hydraulic excavator 10 is lifted and driven in the air. Specifically, the driver slews the slewing structure 14 to the right relative to the traveling structure 11, and in this state, pushes the bucket 17 to the ground. At the time, the direction in which the pedal of the right travel operator 82 is stepped on may be either the forward travel direction or the backward travel direction. The amount by which the pedal is stepped on may be the maximum amount, or may be a constant amount less than the maximum amount.

In this state where the right crawler 13 is driven in the air, the drain pressure of the second hydraulic pump 35 is detected by the pressure meter 72. The control circuitry 6 determines whether or not there is an abnormality in the second hydraulic pump 35 based on the detected drain pressure. For example, the control circuitry 6 may determine whether or not there is an abnormality in the second hydraulic pump 35 by comparing the waveform of the detected drain pressure with a normal waveform, or may determine whether or not there is an abnormality in the second hydraulic pump 35 by comparing the detected drain pressure at a specific timing with a threshold. Alternatively, the control circuitry 6 may determine whether or not there is an abnormality in the second hydraulic pump 35 by performing frequency analysis on the detected drain pressure.

Desirably, the control circuitry 6 determines whether or not there is an abnormality in the second hydraulic pump 35 after confirming that the delivery pressure of the second hydraulic pump 35 is kept to a predetermined value ε. For example, the predetermined value ε is 1 MPa or greater and 20 MPa or less. Alternatively, the predetermined value ε may be 1 MPa or greater and 10 MPa or less.

As described above, in the present embodiment, the drain pressure of the first hydraulic pump 31 is detected in the state where the hydraulic excavator 10 is operated under the predetermined diagnostic conditions related to the first hydraulic pump 31. This makes it possible to determine, with high precision, whether or not there is an abnormality in the first hydraulic pump 31. Also, the drain pressure of the second hydraulic pump 35 is detected in the state where the hydraulic excavator 10 is operated under the predetermined diagnostic conditions related to the second hydraulic pump 35. This makes it possible to determine, with high precision, whether or not there is an abnormality in the second hydraulic pump 35.

In addition, in the present embodiment, the drain pressure of the first hydraulic pump 31 is detected in the state where the left crawler 12 of the hydraulic excavator 10 is lifted and driven in the air, and also, the drain pressure of the second hydraulic pump 35 is detected in the state where the right crawler 13 of the hydraulic excavator 10 is lifted and driven in the air. Therefore, in the hydraulic excavator 10, the predetermined diagnostic conditions related to the first hydraulic pump 31 and the predetermined diagnostic conditions related to the second hydraulic pump 35 can be readily satisfied.

### Variations

The present disclosure is not limited to the above-described embodiment. Various modifications can be made without departing from the scope of the present disclosure.

The state where the hydraulic excavator 10 is operated under the predetermined diagnostic conditions related to the first hydraulic pump 31 need not be the state where the left crawler 12 of the hydraulic excavator 10 is lifted and driven in the air. For example, the state where the hydraulic excavator 10 is operated under the predetermined diagnostic conditions related to the first hydraulic pump 31 may be a state where the hydraulic excavator 10 is driven to slew, or caused to travel, on a flat place. At the time of driving the hydraulic excavator 10 to slew, the slewing structure 14 may be slewed, with the boom 15 and the arm 16 being folded. At the time of causing the hydraulic excavator 10 to travel, the traveling structure 11 may be caused to travel forward or backward. However, in the state where the hydraulic excavator 10 is caused to travel on a flat place, there is a possibility that the pressure related to the first hydraulic pump 31 is not stabilized. Therefore, the above-described embodiment is more desirable.

Similarly, the state where the hydraulic excavator 10 is operated under the predetermined diagnostic conditions related to the second hydraulic pump 35 need not be the state where the right crawler 13 of the hydraulic excavator 10 is lifted and driven in the air. For example, the state where the hydraulic excavator 10 is operated under the predetermined diagnostic conditions related to the second hydraulic pump 35 may be a state where the hydraulic excavator 10 is caused to travel on a flat place. In this case, the traveling structure 11 may be caused to travel forward or backward. However, in the state where the hydraulic excavator 10 is caused to travel on a flat place, there is a possibility that the pressure related to the second hydraulic pump 35 is not stabilized. Therefore, the above-described embodiment is more desirable.

### Summary

One aspect of the present disclosure provides, as a first mode, an abnormality diagnosis system for diagnosing an abnormality in a hydraulic pump of a variable displacement type, the hydraulic pump being installed on a construction machine, the abnormality diagnosis system including: a pressure meter that detects a suction pressure, a delivery pressure, or a drain pressure of the hydraulic pump; and control circuitry that determines whether or not there is an abnormality in the hydraulic pump based on the pressure detected by the pressure meter in a state where the construction machine is operated under predetermined diagnostic conditions. The predetermined diagnostic conditions are a rotation speed and a load of the hydraulic pump being kept constant and a displacement of the hydraulic pump being kept to a predetermined value greater than a minimum value.

According to the above configuration, a pressure related to the hydraulic pump is detected in the state where the construction machine is operated under the predetermined diagnostic conditions. This makes it possible to determine, with high precision, whether or not there is an abnormality in the hydraulic pump.

As a second mode, in the first mode, for example, in a case where the minimum value of the displacement of the hydraulic pump is 0% and a maximum value of the displacement of the hydraulic pump is 100%, the predetermined value may be 50% or greater and 100% or less.

As a third mode, in the first or second mode, for example, the predetermined value may be a first predetermined value, and the control circuitry may determine whether or not there is an abnormality in the hydraulic pump after confirming that the delivery pressure of the hydraulic pump is kept to a second predetermined value.

As a fourth mode, in the third mode, for example, the second predetermined value may be 1 MPa or greater and 20 MPa or less.

As a fifth mode, in any one of the first to fourth modes, the construction machine may include a hydraulic excavator including a pair of crawlers, and the state where the construction machine is operated may be a state where one of the crawlers of the hydraulic excavator is lifted and driven in the air. According to this configuration, in the hydraulic excavator, the predetermined diagnostic conditions can be readily satisfied.

As a sixth mode, in any one of the first to fourth modes, the construction machine may include a hydraulic excavator including a pair of crawlers, and the state where the construction machine is operated may be a state where the hydraulic excavator is driven to slew, or caused to travel, on a flat place. According to this configuration, in the hydraulic excavator, the predetermined diagnostic conditions can be readily satisfied.

Another aspect of the present disclosure provides, as a seventh mode, an abnormality diagnosis method of diagnosing an abnormality in a hydraulic pump of a variable displacement type, the hydraulic pump being installed on a construction machine, the abnormality diagnosis method including, in a state where the construction machine is operated under predetermined diagnostic conditions, detecting a suction pressure, a delivery pressure, or a drain pressure of the hydraulic pump and determining whether or not there is an abnormality in the hydraulic pump based on the detected pressure. The predetermined diagnostic conditions are a rotation speed and a load of the hydraulic pump being kept constant and a displacement of the hydraulic pump being kept to a predetermined value greater than a minimum value.

According to the above configuration, a pressure related to the hydraulic pump is detected in the state where the construction machine is operated under the predetermined diagnostic conditions. This makes it possible to determine, with high precision, whether or not there is an abnormality in the hydraulic pump.

As an eighth mode, in the seventh mode, for example, in a case where the minimum value of the displacement of the hydraulic pump is 0% and a maximum value of the displacement of the hydraulic pump is 100%, the predetermined value may be 50% or greater and 100% or less.

As a ninth mode, in the seventh or eighth mode, for example, the predetermined value may be a first predetermined value, and the control circuitry may determine whether or not there is an abnormality in the hydraulic pump after confirming that the delivery pressure of the hydraulic pump is kept to a second predetermined value.

As a tenth mode, in the ninth mode, for example, the second predetermined value may be 1 MPa or greater and 20 MPa or less.

As an eleventh mode, in any one of the seventh to tenth modes, the construction machine may include a hydraulic excavator including a pair of crawlers, and the state where the construction machine is operated may be a state where one of the crawlers of the hydraulic excavator is lifted and driven in the air. According to this configuration, in the hydraulic excavator, the predetermined diagnostic conditions can be readily satisfied.

As a twelfth mode, in any one of the seventh to tenth modes, the construction machine may include a hydraulic excavator including a pair of crawlers, and the state where the construction machine is operated may be a state where the hydraulic excavator is driven to slew, or caused to travel, on a flat place. According to this configuration, in the hydraulic excavator, the predetermined diagnostic conditions can be readily satisfied.

1. An abnormality diagnosis system for diagnosing an abnormality in a hydraulic pump of a variable displacement type, the hydraulic pump being installed on a construction machine, the abnormality diagnosis system comprising:
a pressure meter that detects a suction pressure, a delivery pressure, or a drain pressure of the hydraulic pump; and
control circuitry that determines whether or not there is an abnormality in the hydraulic pump based on the pressure detected by the pressure meter in a state where the construction machine is operated under predetermined diagnostic conditions, wherein
the predetermined diagnostic conditions are a rotation speed and a load of the hydraulic pump being kept constant and a displacement of the hydraulic pump being kept to a predetermined value greater than a minimum value.

2. The abnormality diagnosis system according to claim 1, wherein in a case where the minimum value of the displacement of the hydraulic pump is 0% and a maximum value of the displacement of the hydraulic pump is 100%, the predetermined value is 50% or greater and 100% or less.

3. The abnormality diagnosis system according to claim 1, wherein
the predetermined value is a first predetermined value, and
the control circuitry determines whether or not there is an abnormality in the hydraulic pump after confirming that the delivery pressure of the hydraulic pump is kept to a second predetermined value.

4. The abnormality diagnosis system according to claim 3, wherein the second predetermined value is 1 MPa or greater and 20 MPa or less.

5. The abnormality diagnosis system according to claim 1, wherein
the construction machine includes a hydraulic excavator including a pair of crawlers, and
the state where the construction machine is operated is a state where one of the crawlers of the hydraulic excavator is lifted and driven in the air.

6. The abnormality diagnosis system according to claim 1, wherein
the construction machine includes a hydraulic excavator including a pair of crawlers, and
the state where the construction machine is operated is a state where the hydraulic excavator is driven to slew, or caused to travel, on a flat place.

7. An abnormality diagnosis method of diagnosing an abnormality in a hydraulic pump of a variable displacement type, the hydraulic pump being installed on a construction machine,
the abnormality diagnosis method comprising, in a state where the construction machine is operated under predetermined diagnostic conditions, detecting a suction pressure, a delivery pressure, or a drain pressure of the hydraulic pump and determining whether or not there is an abnormality in the hydraulic pump based on the detected pressure, wherein
the predetermined diagnostic conditions are a rotation speed and a load of the hydraulic pump being kept constant and a displacement of the hydraulic pump being kept to a predetermined value greater than a minimum value.

8. The abnormality diagnosis method according to claim 7, wherein in a case where the minimum value of the displacement of the hydraulic pump is 0% and a maximum value of the displacement of the hydraulic pump is 100%, the predetermined value is 50% or greater and 100% or less.

9. The abnormality diagnosis method according to claim 7, wherein
the predetermined value is a first predetermined value, and
the step of determining whether or not there is an abnormality in the hydraulic pump is performed after confirming that the delivery pressure of the hydraulic pump is kept to a second predetermined value.

10. The abnormality diagnosis method according to claim 9, wherein the second predetermined value is 1 MPa or greater and 20 MPa or less.

11. The abnormality diagnosis method according to claim 7, wherein
the construction machine includes a hydraulic excavator including a pair of crawlers, and
the state where the construction machine is operated is a state where one of the crawlers of the hydraulic excavator is lifted and driven in the air.

12. The abnormality diagnosis method according to claim 7, wherein
the construction machine includes a hydraulic excavator including a pair of crawlers, and
the state where the construction machine is operated is a state where the hydraulic excavator is driven to slew, or caused to travel, on a flat place.
